(19) United States
(12) Patent Application Publication
(10) Pub. No.: US 2023/0321938 A1
(43) Pub. Date: Oct. 12, 2023

(54) A SYSTEM AND PROCESS OF MANUFACTURING OF A SALT BRIQUETTE

(71) Applicant: Deepak Nitrite Limited, Vadodara (IN)

(72) Inventor: A S SARMA, Vadodara (IN)

(21) Appl. No.: 18/023,192

(22) PCT Filed: Sep. 7, 2021
(86) PCT No.: PCT/IB2021/058120

§ 371 Date: Feb. 24, 2023

(30) Foreign Application Priority Data
Sep. 7, 2020 (IN) 202021019408

(51) Int. Cl. B30B 15/30; C01D 13/00; C01D 9/18; B30B 11/18; B30B 11/16

(52) U.S. Cl. CPC B30B 15/308; C01D 13/00; C01P 2006/80; B30B 11/18; B30B 11/16; C01D 9/18

(57) ABSTRACT

A system and method of briquette formation of hygroscopic metallic salts. The system including a feed hopper unit, a vibrating sieve unit, a briquetting unit, a belt conveyer, a bucket elevator, a double deck vibrating sieve unit, a product hopper unit, a by-product hopper unit, and a product and by product packing unit. the briquetting unit comprising an inclined screw conveyer unit is configured for pushing hygroscopic salt material into the briquetting unit, one or more briquette rollers configured for compression of feed material into briquette stripes and a cutting assembly configured to cut briquette stripes and to obtain the briquette of hygroscopic metallic salt. Hygroscopic metallic salt briquette manufactured by the process is easy to handle, transportable, storage stable and causes minimum loss of salt before the end use.

### TECHNICAL FIELD

The present subject matter described herein, in general relates to a system and method of briquette formation. In particular, the present subject matter is related to the system and process of briquetting of sodium salts.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In the present scenario, metallic salts such as sodium and calcium salts are widely used in different applications. A type of a sodium salt i.e., sodium nitrite is used as a fertilizer, starting material for various diazotization reactions, food preservatives etc. However, handling of such salts is often a tedious task. This is because, most of the sodium and calcium salts are either hygroscopic, water soluble or moisture prone exposed to open environment. Such properties of sodium and calcium salts lead to inconsistent shapes such as lumps. Handling and transportation the metallic salts is always difficult as they easily get contaminated and therefore does not comply with standards.

Therefore, there is a long felt need of venturing a system and method of manufacturing an easy to handle, transport and storage stable form of the metallic form in the industry. The present disclosure describes about a system and process of manufacturing and packaging of the hygroscopic metallic salts in form of a compressed shape such as a briquetted form.

### SUMMARY

Before the present system and its components are described, it is to be understood that this disclosure is not limited to the particular system and its arrangement as described, as there can be multiple possible embodiments which are not expressly illustrated in the present disclosure. It is also to be understood that the terminology used in the description is for the purpose of describing the particular versions or embodiments only and is not intended to limit the scope of the present application.

This summary is provided to introduce concepts related to a system and process of manufacturing and packaging of the hygroscopic metallic salts in form of a compressed shape such as a briquetted form. This summary is not intended to identify essential features of the claimed subject matter nor it is intended for use in determining or limiting the scope of the disclosed subject matter.

In one embodiment, a system for manufacturing a briquette comprising a hygroscopic metallic salt is disclosed herein. In one embodiment, the hygroscopic metallic salt may be sodium nitrite briquette. The system may comprise a feed hopper unit, a vibrating sieve unit, a briquetting unit, a belt conveyer, a bucket elevator, a double deck vibrating sieve unit, a product hopper unit, a by-product hopper unit, a product and by product packing unit. The briquetting unit may comprise the inclined conveyer unit. In one embodiment, the inclined conveyer unit may be an inclined screw conveyor unit. The inclined conveyer unit may be configured for pushing hygroscopic salt material into the briquetting unit. The briquetting unit may comprise one or more briquette rollers comprising a plurality of grooves configured for compression of feed material into briquette stripes. Further, briquetting unit may comprise a breaker unit configured to break briquette stripes into small pieces and a cutting assembly configured to cut briquette stripes and to obtain the briquette of hygroscopic metallic salt.

In another embodiment, a process of manufacturing a briquette comprising a hygroscopic metallic salt is disclosed herein. In one embodiment, the hygroscopic metallic salt may be sodium nitrite briquette. The process may comprise feeding of the hygroscopic metallic salt feed to a feed hopper unit. Further the process may comprise removing lumps from the hygroscopic metallic salt feed using a vibrating sieve unit to obtain a uniform powder of a predefined sieve size of the metallic salt feed. Further the process may comprise inclined conveying of the hygroscopic metallic salt to the briquetting unit. Further the process may comprise briquetting of the hygroscopic metallic salt via a briquetting unit to obtain a hygroscopic metallic salt briquette. Further the process may comprise compressing the hygroscopic metallic salt briquette to form a hygroscopic metallic salt briquette stripe using one or more briquet rollers comprising a plurality of grooves. Further the process may comprise cutting the hygroscopic metallic salt briquette stripe using a cutting assembly. In one embodiment, the cutting assembly may be situated at the end of the briquetting unit to obtain a metallic salt briquette. Further the process may comprise transferring the hygroscopic metallic salt briquette to a bucket elevator by using a belt conveyor. Further the process may comprise passing of the hygroscopic metallic salt briquette using the bucket elevator to a double deck vibrating sieve unit. Further, the process may comprise separating any loosely bound lumps of metallic salt and the metallic salt briquette. Furthermore, the process may comprise separately collecting the metallic salt briquette stripe and a by-product.

In another embodiment, a purified form of sodium nitrite briquette is disclosed herein. The sodium nitrite briquette may comprise: 0.001-0.1 ppm of mercury; comprising 0.001-0.1 ppm of cadmium; comprising 100-400 ppm of potassium; comprising 0.001-0.1 ppm of chromium; comprising 0.001-0.1 ppm of manganese; comprising 0.001-0.1 ppm of nickel; comprising 0.01-1.0 ppm of fluoride; comprising 0.01-0.20 ppm of copper; comprising 0-20 ppm of lead; comprising 0.01-0.20 ppm of zinc; and comprising 0.001-0.1 ppm of arsenic.

In another embodiment, the purified form of sodium nitrite briquette is obtained with a purity level between 98% to 101%, and preferably between 99.0-99.90%.

In another embodiment, an amount of loss on drying of the sodium nitrite briquette may be 0.001%-0.25%, and preferably 0.11-0.12%.

In another embodiment, the heavy metal content of sodium nitrite briquette is between 0.0000%-0.002%, wherein the heavy metal may comprise at least lead (Pb), and wherein the content of lead (Pb) is less than 0.1 ppm. i.e., 0.00001%.

In another embodiment, the heavy metal content of sodium nitrite briquette is 0.00 mg/kg-20 mg/kg, wherein the heavy metal may comprise at least lead (Pb), and wherein the content of lead (Pb) is less than 0.1 mg/kg.

In another embodiment, the sodium nitrite briquette may comprise chloride content between 5.0 ppm-100 ppm and more preferably between 80-90 ppm.

In another embodiment, the sulphate content of sodium nitrite briquette is between 10 ppm-200 ppm.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates, a block diagram depicting a system (100) for manufacturing a metallic salt briquette, in accordance with embodiments of the present disclosure.

FIG. 2 illustrates, a flow diagrams depicting a process (200) for manufacturing a metallic salt briquette, in accordance with embodiments of the present disclosure.

FIG. 3 illustrates, an image depicting a packed sodium nitrite briquette product obtained by the process (200) for manufacturing a metallic salt briquette, in accordance with embodiments of the present disclosure.

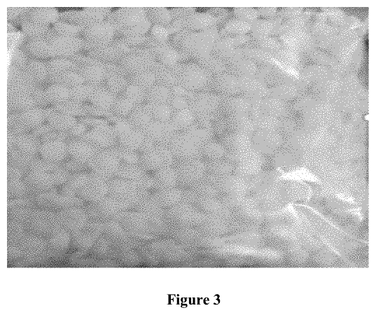

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items.

It must also be noted that, the singular forms “a,” “an,” and “the” include plural references unless the context clearly dictates otherwise. Although any methods or processes similar or equivalent to those described herein can be used in the practice or testing of embodiments of the present disclosure, the exemplary methods are described. The disclosed embodiments are merely exemplary of the disclosure, which may be embodied in various forms.

Various modifications to the embodiment may be readily apparent to those skilled in the art and the generic principles herein may be applied to other embodiments. However, one of ordinary skill in the art may readily recognize that the present disclosure is not intended to be limited to the embodiments illustrated but is to be accorded the widest scope consistent with the principles and features described herein.

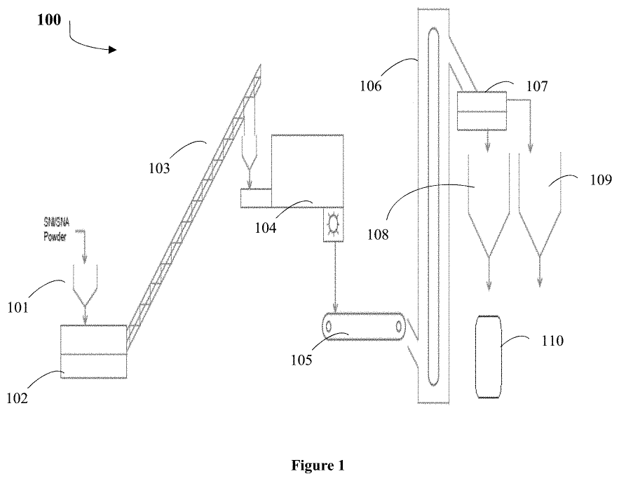

Now referring to FIG. 1, a block diagram of a system (100) for manufacturing a briquette comprising a hygroscopic salt is illustrated, in accordance with an embodiment of the present disclosure.

The system (100) may comprise a feed hopper unit (101), a vibrating sieve unit (102), an inclined screw conveyer unit (103), a briquetting unit (104) comprising briquette rollers having a plurality of grooves, a belt conveyer (105), a bucket elevator (106), a double deck vibrating sieve unit (107), a product hopper unit (108), a by-product hopper unit (109), and a product and by product packing unit (110).

In one embodiment, the feed hopper unit (101) may be configured for continuous intake of a metallic salt feed from a drying unit (not shown in figure) in a controlled manner. In one embodiment the drying unit is a Multi Effect Evaporator (MEE) unit configured for intaking the metallic salt feed to the feed hopper unit. More specifically, this dried feed undergoes different unit operations like evaporation, settling, filtration, and drying and then will become feed to this feed hopper unit (101). The feed hopper unit (101) may be connected to the vibrating sieve unit (102). The said vibrating sieve unit (102) may be configured to remove lumps from the metallic salt feed and to obtain a uniform powder of a predefined sieve size from the metallic salt feed and to stop any lump material or any foreign material to enter into the briquette machine. In one embodiment, the vibrating sieve unit (102) positioned at feed end of the inclined conveyer unit (103) is a vibro-sifter unit.

The inclined conveyer unit (103) may be configured for inclined conveying of the powder of the metallic salt from the vibrating sieve unit (102) to the briquetting unit (104) at a predefined speed within a range of 20-60 percent and more preferably 30-40 percent of Variable Frequency Drive (VFD)), and eliminating loss in handling of the salt. In one embodiment, the inclined conveyer unit (103) may be an inclined screw type conveyor.

The briquetting unit (104) may comprise a screw feeder assembly, one or more briquette rollers comprising a plurality of grooves and a cutting assembly. The screw feeder assembly for pitching/pushing material into the briquetting unit (104) and positioned at the bottom. The briquetting unit (104) may further comprise a breaker unit (not shown in figure) configured to break briquette stripes or sheet into small pieces. The briquetting unit (104) may be further configured to pack the crystals of the metallic salt into a briquette shape of a predefined size dimension by optimizing a compression technique. The plurality of grooves of the briquette rollers may decide the compactness and size of the briquettes based on the roll compactors. The grooves are engraved pockets or dyes configured to compact feed material into metal salt briquettes.

In one exemplary embodiment, the total number of engraved pockets may be approximately between 3500-5500, and preferably 3900-4100 with a pitch of 10-15 mm center to center and gap of 1-3 mm between each pocket. In another embodiment, diameter of roller may be 50-400 mm, length of approx. 280-490 mm. The pocket length is 7-10 mm, width 1-4 mm, and depth of each of the pocket is between 1-4 mm, and preferably 2.2 mm. The specific arrangement of engraved pockets is modified to ensure the strength of the briquette 2-5 kg/cm², and size dimension of each of the briquette having height 6-8 mm and width 5-7 mm without disturbing the properties of the parent material and keeping the integrity of the material.

The said belt conveyer unit (105) may be further connected to the bucket elevator (106) and enables conveying of the metallic salt material and briquette stripe from briquetting unit (104) to the bucket elevator (106) for further processing. The bucket elevator (106) may be configured to feed the briquette material and briquette strips to the double deck vibrating sieve unit (107) configured to separate briquette material, briquette strip and fine powder. This double deck vibrating sieve unit (107) is differed from normal vibro-sifter by adding a tumbler kind of motion which breaks the stripe into the above said products. The double deck vibrating sieve unit (107) may be further connected to the product hopper unit (108) and the by-product hopper unit (109), both configured for the storage of briquette material coming out from double deck vibrating sieve unit (107).

More particularly, the product hopper unit (108) may be configured to collect the briquette shaped strips of the metallic salt. Furthermore, the by-product hopper unit (109) adjacent to the product hopper unit may be configured to collect the by-product comprising unprocessed lumps and powder of the metallic salt separated from the briquettes by the double deck vibrating sieve unit (107). The product hopper unit (108) may be further configured to pass the metallic salt briquette to a product packaging unit enabled to pack the briquettes from product hopper unit (108) and to pack by-product material from by-product hopper unit (109).

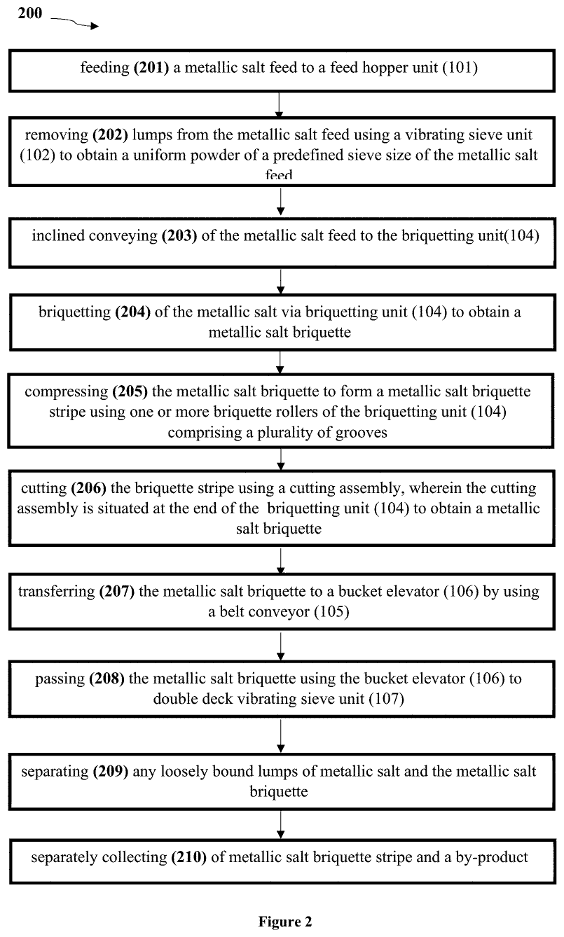

Now referring to FIG. 2, a process (200) of manufacturing a briquette comprising a hygroscopic salt is depicted, in accordance with an embodiment of the present disclosure.

The process (200) may comprise various steps to obtain a compressed briquette of a hygroscopic salt as described below:

At step (201), the process may comprise feeding a metallic salt feed to a feed hopper unit (101).

At step (202), the process may comprise removing lumps from the metallic salt feed using a vibrating sieve unit (102) to obtain a uniform powder of a predefined sieve size of the metallic salt feed.

At step (203), the process may comprise inclined conveying (203) of the metallic salt to the briquetting unit (104).

At step (204), the process may comprise briquetting of the metallic salt via briquetting unit (104) to obtain a metallic salt briquette.

At step (205), the process may comprise compressing the metallic salt briquette to form a metallic salt briquette stripe using one or more briquet rollers comprising a plurality of grooves.

At step (206), the process may comprise cutting the briquette stripe using a cutting assembly, wherein the cutting assembly is situated at the end of the briquetting unit (104) to obtain a metallic salt briquette.

At step (207), the process may comprise transferring the metallic salt briquette to a bucket elevator (106) by using a belt conveyor (105).

At step (208), the process may comprise passing the metallic salt briquette using the bucket elevator (106) to double deck vibrating sieve unit (107).

At step (209), the process may comprise separating (209) any loosely bound lumps of metallic salt and the metallic salt briquette.

At step (210), the process may comprise separately collecting of metallic salt briquette stripe and a by-product.

In one embodiment, the metallic salt may be at least one of nitrite, chloride, nitrate etc. More preferably, the metallic salt may be at least one of sodium nitrite (SNI) and sodium nitrate (SNA). The sodium nitrite briquette manufactured by the process (200) using the system (100) is easy to handle, transportable, storage stable and causes minimum loss of salt before the end use.

In yet another embodiment, the sodium nitrite briquette provided herein may comprise 0.001-0.1 ppm of mercury, more preferably contains <0.1 ppm of mercury. The mercury content in the sodium nitrite briquette provided herein is determined using the inductively coupled plasma-optical emission spectrometry (ICP-OES).

In yet another embodiment, the sodium nitrite briquette provided herein may comprise 0.001-0.1 ppm of cadmium, more preferably contains <0.1 ppm of cadmium. The cadmium content in the sodium nitrite briquette provided herein is determined using ICP-OES.

In yet another embodiment, the sodium nitrite briquette provided herein may comprise 100-400 ppm of potassium, more preferably contains 304 ppm of potassium. The potassium content in the sodium nitrite briquette provided herein is determined using ICP-OES.

In yet another embodiment, the sodium nitrite briquette provided herein may comprise 0.001-0.1 ppm of chromium, more preferably contains <0.1 ppm of chromium. The chromium content in the sodium nitrite briquette provided herein is determined using ICP-OES.

In yet another embodiment, the sodium nitrite briquette provided herein may comprise 0.001-0.1 ppm of manganese, more preferably contains <0.1 ppm of manganese. The manganese content in the sodium nitrite briquette provided herein is determined using ICP-OES.

In yet another embodiment, the sodium nitrite briquette provided herein may comprise 0.001-0.1 ppm of nickel, more preferably contains <0.1 ppm of nickel. The nickel content in the sodium nitrite briquette provided herein is determined using ICP-OES.

In yet another embodiment, the sodium nitrite briquette provided herein may comprise 0.01-1.0 ppm of fluoride, more preferably contains <1.0 ppm of fluoride. The fluoride content in the sodium nitrite briquette provided herein is determined using Ion chromatography (IC).

In yet another embodiment, the sodium nitrite briquette provided herein may comprise 0.01-0.20 ppm of copper, more preferably contains 0.15 ppm of copper. The copper content in the sodium nitrite briquette provided herein is determined using ICP-OES.

In yet another embodiment, the sodium nitrite briquette provided herein may comprise preferably between 0-20 ppm of lead i.e., less than 20 ppm and more preferably contains <0.1 ppm of lead. The lead content in the sodium nitrite briquette provided herein is determined using ICP-OES.

In yet another embodiment, the sodium nitrite briquette provided herein may comprise 0.01-0.20 ppm of zinc, more preferably contains 0.20 ppm of zinc. The zinc content in the sodium nitrite briquette provided herein is determined using ICP-OES.

In yet another embodiment, the sodium nitrite briquette provided herein may comprise 0.001-0.1 ppm of arsenic, more preferably contains <0.1 ppm of arsenic. The arsenic content in the sodium nitrite v provided herein is determined using ICP-OES.

In yet another embodiment, the sodium nitrite briquette provided herein comprising one or more of the following:
0.001-0.1 ppm of mercury;
0.001-0.1 ppm of cadmium;
100-400 ppm of potassium;
0.001-0.1 ppm of chromium;
0.001-0.1 ppm of manganese;
0.001-0.1 ppm of nickel;
0.01-1.0 ppm of fluoride;
0.01-0.20 ppm of copper;
0-20 ppm of lead;
0.01-0.20 ppm of zinc;
0.001-0.1 ppm of arsenic.

In another embodiment, the process may comprise a step of obtaining the purified form of sodium nitrite briquette with a purity level between 98% to 101%, preferably between 99%-99.90%, and more preferably between 99-99.1%.

In another embodiment, an amount of loss on drying of the sodium nitrite briquette is 0.001%-0.25%, wherein heavy metal content of sodium nitrite briquette is 0.0000%-0.002%, wherein the heavy metal may comprise lead (Pb), and wherein content of lead (Pb) is less than 0.1 ppm. i.e., 0.00001%.

In another embodiment, an alkalinity of the sodium nitrite briquette may be between 0.06-0.09% and preferably between 0.07-0.08%.

In another embodiment, the sodium nitrite briquette may comprise chloride content between 5.0 ppm-100 ppm and more preferably between 80-90 ppm.

In another embodiment, the sodium nitrite briquette may comprise sodium nitrate content between 0.3-1% and preferably 0.5-0.7%.

In another embodiment, the sodium nitrite briquette may comprise sulphate content of the sodium nitrite briquette was 10 ppm-200 ppm.

In another embodiment, the heavy metal content of the sodium nitrite briquette is 0.00 mg/kg-20 mg/kg, wherein the heavy metal may comprise at least lead (Pb), and wherein content of lead (Pb) is less than <0.1 ppm˜0.1 mg/kg.

In another embodiment, a content of water insoluble impurities may be between 0.012-0.016%.

In yet another embodiment, strength of each of the briquette of sodium nitrite is between 1.5-3 kg/Cm′.

### EXAMPLES

Table 1 discloses a comparative analytical data of the sodium nitrite briquette obtained by the process (200) of manufacturing a briquette comprising a hygroscopic salt.

| Sr. | | | | | | | |
|---|---|---|---|---|---|---|---|
| no | Test Parameter | Batch 1 | Batch 2 | Batch 3 | Batch 4 | Batch 5 | Batch 6 |
| 1 | PURITY (On Dry | 99 | 99.01 | 99.01 | 99.01 | 99 | 99 |
| | Basis) | | | | | | |
| | (99.00% w/w Min) | | | | | | |
| 2 | LOSS ON DRYING | 0.11 | 0.11 | 0.1 | 0.11 | 0.11 | 0.12 |
| | (0.50% w/w Max.) | | | | | | |
| 3 | ALKALINITY | 0.08 | 0.08 | 0.07 | 0.09 | 0.08 | 0.07 |
| | as Na₂CO₃ | | | | | | |
| | (0.20% w/w Max.) | | | | | | |
| 4 | CHLORIDE as Cl | 0.009 | 0.009 | 0.009 | 0.009 | 0.009 | 0.009 |
| | (0.05% w/w Max.) | | | | | | |
| 5 | SODIUM NITRATE | 0.62 | 0.62 | 0.62 | 0.62 | 0.62 | 0.62 |
| | (1.00% w/w Max.) | | | | | | |
| 6 | WATER | 0.014 | 0.012 | 0.012 | 0.012 | 0.016 | 0.014 |
| | INSOLUBLE | | | | | | |
| | (0.05% w/w Max.) | | | | | | |
| 7 | SULPHATE | COMPLIES | COMPLIES | COMPLIES | COMPLIES | COMPLIES | COMPLIES |
| | AS SO₄ | | | | | | |
| | (0.05% w/w Max.) | | | | | | |
| 8 | IRON as Fe | COMPLIES | COMPLIES | COMPLIES | COMPLIES | COMPLIES | COMPLIES |
| | (0.002% w/w Max.) | | | | | | |
| 9 | HEAVY | <0.10 | <0.10 | <0.10 | <0.10 | <0.10 | <0.10 |
| | METAL as Pb | | | | | | |
| | (50 ppm Max.) | | | | | | |
| 10 | 40% CLARITY | CLEAR | CLEAR | CLEAR | CLEAR | CLEAR | CLEAR |
| | (It should be | | | | | | |
| | clear solution) | | | | | | |
| 11 | Strength (Min | 1.5-3 | 1.5-3 | 1.5-3 | 1.5-3 | 1.5-3 | 1.5-3 |
| | 1.0 kg/Cm²) | | | | | | |
| 12 | SIZE OF | 5 to 6 | 5 to 6 | 5 to 6 | 5 to 6 | 5 to 6 | 5 to 6 |
| | HEIGHT | | | | | | |
| | (7 mm Max.) | | | | | | |
| 13 | SIZE OF | 7 to 8 | 7 to 8 | 7 to 8 | 7 to 8 | 7 to 8 | 7 to 8 |
| | WIDTH | | | | | | |
| | (8 mm Max.) | | | | | | |

Test-1: Purity Testing Method of Sodium Nitrite

In one embodiment, a purity of Sodium nitrite in Table 1 was tested using a following method: An amount of 3.16 gm KMnO₄ was dissolved in 100 ml D M water. The solution of KMnO₄ were then digested over a hot plate for one hour. The KMnO₄ solution was cooled filtered through Grade 4 sintered glass funnel without applying vacuum for 24 hours. After 24 hours KMnO₄ solution was diluted 1000 ml by demineralized water (DM) water. The solution was standardized same for exact normality of 0.1N. An accurately about 1.0 gm dry sodium nitrite test sample (2.0 to 3.0 gm for liquid) was taken and diluted to 250 ml volumetric flask by Dist. water. A 20 ml of 0.1 N KMnO₄ were taken in solutions in 250 ml beaker and 5 ml of concentrated H₂SO₄ in 50 ml Dist. Water were added. The temperature was maintained to about 40° C. and titration was performed by NaNO₂ solution from Burette, keeping the tip of the burette under the surface of KMnO₄ solution with continuous stirring. NaNO₂ solution were added very slowly. The end point was observed as pink to colourless and the Burette reading (BR) was noted to obtain results in the Table. 1.

% of sodium nitrite in the dry of sodium nitrite test sample was calculated as below:

$$\% w / w sodium nitrite = \frac{Norm ality of KMnO 4 \times 34.5 \times 100 \times 250 \times 20}{Gram sample \times 1000 \times B . R .}$$

Test-2: Loss on Drying (LOD) of Sodium Nitrite

In one embodiment, an amount of loss on drying of all forms Sodium nitrite in Table 1 was tested using a Mettler Toledo Halogen Moisture Analyzer Model-HG-53 and by following method:

Following protocol was followed to test the LOD: Start the instrument, pre-heat the empty aluminium pan (foil) at temp +/−100° C. for five minutes. Then take the quantity mansion in bellow table. Set the temperature & time as mentioned in below table. Press Start key and observe the final reading directly as % loss on drying.

| | | Temp ° C. +/− | |
|---|---|---|---|
| Sample | Sample quantity | 2° C. | Time Minutes |
| NaNO₂ samples | 5 gm | 110 | 10 |
| of Table 1 | | | |

Test-3: Alkalinity by Content of Na₂CO₃ Impurity in the Forms of SNI

In one embodiment, an alkalinity content of all forms Sodium nitrite in Table 1 was tested using a following method:
(a) Reagents used: 0.1 N H₂SO₄ Solution; 0.1 N H₂SO₄ is prepared by mixing 2.82 ml. of pure Sulphuric acid in water and dilute to 1000 ml by distilled water, standardize it.
(b) 0.1% w/v Phenolphthalein indicator solution: Dissolve 0.1 gm of Phenolphthalein powder in 80 ml of 95% methanol and finally dilute to 100 ml with distilled water.

Protocol followed:

Weigh accurately nearest to 25 gm of sample and transfer it to 250 ml conical flask. Add 50 ml of distilled water and boil it for five minutes, Cool it, and add 4 to 5 drops of Phenolphthalein Indicator. Titrate against 0.1 N Sulphuric acid till pink colour to colourless end point. Note the burette reading (BR).

% of content of Na₂CO₃ impurity in the forms of SNI in the dry of sodium nitrite test sample was calculated as below:

$$\% w / w alkalinity as sodium carbonate = \frac{B R \times 2 \times Normality of H 2 SO 4 \times 53 \times 100}{Gram sample \times 1000}$$

Test-4: Impurity Content of Chloride as Cl

In one embodiment, a chloride content of all forms Sodium nitrite in Table 1 was tested using a following method:

Reagents used:
(a) Nitric acid pure (70% w/w)
(b) Standard Silver Nitrate solution—0.1 N: Dissolve 17 gm Silver Nitrate pure in DM water and dilute to 1000 ml in volumetric flask and Standardise it.
(c) Nitrobenzene pure
(d) Standard Ammonium thiocyanate solution—0.1 N: Dissolve of 7.6 gm Ammonium thiocyanate pure in 400 ml of DM water and dilute to 1000 ml in volumetric flask and standardize it.
(e) Ferric Ammonium Sulphate indicator saturated solution: Dissolve Ferric Ammonium Sulphate pure in DM water up to saturated solution.

Protocol followed:

Weigh accurately nearest to 10 gm of sample (Suitable quantity) in 250 ml conical flask. Add about suitable quantity of Nitric acid depending as product to be analysis till removal of Nitrous gas. Add 10 ml of 0.1 N Silver Nitrate solutions. Add 5.0 ml Nitrobenzene and shake vigorously. Titrate it against 0.1 N Ammonium Thiocyanate solutions, using 1 ml Ferric Ammonium Sulphate indicator solution. Note the burette reading (BR). End point will be faint brown in colour.

% of content of Chloride (Cl) impurity in the forms of SNI in the dry of sodium nitrite test sample was calculated as below:

$$\% w / w alkalinity as Chloride as Cl = \frac{35.5 \times [ ( N of AgNO 3 \times 10 ) - ( BR \times N of NH4SCN ) ] \times 100}{Gram sample \times 1000}$$

Test-5: Impurity Content of Sodium Nitrate

In one embodiment, an impurity content of sodium nitrate of all forms Sodium nitrite in Table 1 was tested using a following method:

Reagents required:
(a) Phenol Sulphonic acid reagent: Take 24 gm Phenol in Conical flask, add 12 ml distilled water, add 150 ml AR grade Con.H2SO4. Heat it on water bath for two to three hours and store in umber colour glass bottle.
(b) Standard NaNO₃ solution (1 m=0.1 mg NaNO3): Take 1.0 gm NaNO₃ AR grade diluted to 1000 ml distilled water. This will be 1 ml=1 mg NaNO3. Further Take 25 ml of this solution & dilute it to 250 ml with distilled water. This will be 1 ml=0.1 mg NaNO3 Standard solution.
(c) Liquid NH₃ AR Grade (23% w/w)
(d) Hydroxylamine Sulphate pure

Protocol followed:
(A) Sample Preparation: Take 0.2 gm dry sample; add 0.70 gm AR grade Hydroxyl Amine Sulphate slowly as reaction is vigorous. Put in on water bath in fuming cupboard. After complete evaporation to dryness, (During evaporation to dryness, no other analysis is to be carried out along with this test in the same fuming cupboard). Cool it at room temperature. Add 2 ml Phenol Sulphonic acid reagent, moisten the residue by rotating the dish carefully, put it on water bath for 15 minutes, and cool it at room temperature. Transfer in 100 ml volumetric flask with cooling condition (use Ice batch) by distilled water, add 5 ml Liquid NH3 solution slowly with cooling till yellow colour observed, (NH3 solution should be added till alkaline), dilute it to 100 ml by distilled water. Prepare reagent blank without sample. Set the zero by reagent blank at 410 nm in the Spectrophotometer. Now take the absorbance of sample solution at 410 nm using 1 cm glass cell.
(B) For standard NaNO₃: Take 10 ml 1 ml=0.1 mg·NaNO₃ solution in Glass evaporating dish. Put it on water bath for evaporating to dryness, (During evaporation to dryness no other analysis is to be carried out along with this test in the same fuming cupboard). Cool it at room temperature. Add 2 ml Phenol Sulphonic acid reagent, moisten the residue by rotating the dish carefully, put it on water bath for 15 minutes, and transfer it to 100 ml in volumetric flask using distilled water under cooling condition (use Ice bath). Add 5 ml NH3 slowly with cooling condition till yellow colour observed, (NH3 solution should be added till alkaline) dilute to 100 ml with water. Prepare reagent blank without sample. Set the zero by reagent blank at 410 nm in the spectrophotometer. Take absorbance at 410 nm using 1 cm glass cell. % of content of Sodium Nitrate (NaNO₃) impurity in the forms of SNI in the dry of sodium nitrite test sample was calculated as below:

$$\% \frac{w}{w} NaNO2 = \frac{Absorbance of Sample \times 0.1 \times 10 \times 100}{Absorbance of standard NaNO3 \times weigh of sample \times 1000}$$

Test-6: Impurity Content of Iron as Fe3+

In one embodiment, an impurity content of Iron as Fe3+ of all forms Sodium nitrite in Table 1 was tested using a following method:

Reagents used:
(a) Hydrochloric acid pure 30% w/w
(b) Sulphuric acid pure 98% w/w
(c) 10% w/v Sulphuric acid: Take 10 ml Con H₂SO₄ and dilute to 100 ml very carefully by cold DM Water. Add H₂SO₄ slowly In cold D M water.
(d) 30% w/v Potassium Thiocyanate solution: Dissolve 30 gm of pure Potassium Thiocyanate in D M water and dilute to 100 ml in volumetric flask.
(e) Standard Iron Solution Dissolve 0.7022 g of ferrous ammonium Sulphate (Fe (NH4)₂ SO₄ 6H₂O) in 10 ml of 10% Sulphuric acid. From the Burette add 0.1 N Potassium permanganate solutions till pink colour persists for few seconds. Dilute to 1000 ml in a volumetric flask 01 ml=0.1 mg of Fe). 10 ml of this solution dilute to 100 ml in volumetric flask (1 ml=0.01 mg Fe).

Protocol followed:

Take 5 gm of the Sample (suitable quantity) in glass evaporating dish and evaporate to dryness it on electric burner. Then cool it. Add 7 ml Sulphuric acid solution. Repeat the evaporation to dry the sample, cool the sample and add 2 ml Conc. HCl, add slight DM water, warm it, shake it, and filter the solution by 42. Filter paper in Nessler cylinder. Add 3 ml 30% Potassium thiocyanate solution, dilute to 50 ml by DM water. A blank experiment is carried out using 2 ml of Conc. HCL and 3 ml of 30% Potassium thiocyanate solution and dilute to 50 ml by DM water. From the micro burette add standard Iron solution (1 ml=0.01 mg Fe) till the red colour matches with the colour produced by sample. Note the matching as Burette reading (BR).

% of content of Iron as Fe3+ impurity in the forms of SNI in the dry of sodium nitrite test sample was calculated as below:

$$Iron as Fe w / w ppm = \frac{BR \times 0.01 \times 1000}{gm sample}$$

Test-7: Impurity Content of Heavy Metal as Pb

In one embodiment, an impurity content of heavy metal Pb of all forms Sodium nitrite in Table 1 was tested using a following method:

Reagents used:
(a) Concentrated Hydrochloric acid pure (30% w/w)
(b) Nitric Acid pure (70% w/w)
(c) Standard lead solution (1 ml=0.01 mg): Dissolve 1.600 gm Lead Nitrate pure in water and 1 ml of concentrated Nitric acid and make the volume up to 1000 ml mark by D M water. Transfer exactly 10 ml of this solution to a 1000 ml volumetric flask, again dilute with D M water and make up the volume to 1000 ml mark. 1 ml of this solution is equivalent to 0.01 mg of Lead (Pb)
(d) 6% w/v Dilute Acetic acid solution: Take 6 ml, acetic acid and dilute it to 100 ml by D M water in volumetric flask.
(e) Hydrogen Sulphide solution: Prepare fresh solution using concentrated Hydrochloric acid and Iron pyrites (Ferrous Sulphide).

Protocol followed:

Take 10 gm sample (Suitable quantity) in glass dish add 25 ml D M water, dissolve it, add 25 ml concentrated hydrochloric acid and evaporate to dryness on water-bath until the odor of hydrochloric acid is no longer perceptible. Dissolve the residue in 30 ml DM water; transfer it to 100 ml Nessler cylinder. If solution is dark/black, then solution pass through activated carbon (Charcoal powder) & collect the clear colorless solution. In this clear color solution, add 2 ml dil. Acetic acid & pass H2S gas for 1 minutes & dilute 50 ml mark See the dark colour and compare it with standard colour of Lead.

Standard Lead Colour: Take 10 ml, 20 ml & 50 ml of 1 ml=0.01 mg Lead standard solution in different 100 ml Nessler cylinders, add 2 ml dilute acetic acid, add 10 ml Hydrogen Sulfide solution, or pass H2S gas dilute to 50 ml mark. See the dark colour and compare with above dark colour of sample solution. If sample colour is less than the standard colour then sample is passing.

% of content of Lead as Pb impurity in the forms of SNI in the dry of sodium nitrite test sample was calculated as below:

$$Lead as Pb w / w ppm = \frac{BR \times 0.01 \times 1000}{gm sample}$$

Test-8: Clarity of Solution

In one embodiment, a clarity of sodium nitrate solution of all forms Sodium nitrite in Table 1 was tested using a following method:

Prepare a solution in DM water as per specification concentration. Stir well up to dissolve the product, then warm and cool at room temperature. See the clarity of solution and note the observation.

The embodiments, examples, and alternatives of the preceding paragraphs or the description and drawings, including any of their various aspects or respective individual features, may be taken independently or in any combination. Features described in connection with one embodiment are applicable to all embodiments unless such features are incompatible.

1. A system for manufacturing a briquette of hygroscopic metallic salt comprising:
a feed hopper, a vibrating sieve unit, a briquetting unit, a belt conveyer, a bucket elevator, a double deck vibrating sieve unit, a product hopper unit, a by-product hopper unit, and a product and by product packing unit; wherein
the briquetting unit comprising an inclined screw conveyer unit configured for pushing hygroscopic salt material into the briquetting unit, the briquetting unit further comprising one or more briquette rollers having a plurality of grooves configured for compression of feed material into briquette stripes, a breaker unit configured to break briquette stripes into small pieces, and a cutting assembly configured to cut briquette stripes and to obtain the briquette of hygroscopic metallic salt.

2. The system as claimed in claim 1, wherein the feed hopper unit is enabled for continuous feeding of a metallic salt feed from a drying unit.

3. The system as claimed in claim 2, wherein the drying unit is a Multi Effect Evaporator (MEE) unit.

4. The system as claimed in claim 1, wherein vibrating sieve unit is configured to separate lumps from a powder form of metallic salt at a predefined speed within a range of 20-60 percent of Variable Frequency Drive (VFD).

5. The system as claimed in claim 1, wherein the inclined conveyer unit is an inclined screw type conveyor.

6. The system as claimed in claim 1, wherein the belt conveyer is enabled to transfer the metallic salt briquette stripe to the bucket elevator.

7. The system as claimed in claim 1, wherein the briquette rollers having a plurality of grooves are configured for compression (the compressive strength is maintained by pressure adjustment (10-20 kg/cm2) as per the clearance between the two rollers by hydraulic systems) of feed material into briquette stripes.

8. The system as claimed in claim 1, wherein the plurality of grooves are roll compactors made with engraved pockets or dies configured to compact feed material into briquettes.

9. The system as claimed in claim 8, wherein the total number of engraved pockets may be approx. 4000 with a pitch of 10-15 mm center to center and gap of 1-3 mm between each pocket.

10. The system as claimed in claim 8, wherein a diameter each of a roller of the roll compactors is 50-400 mm, length 280-490 mm, and wherein length of pocket is between 7-10 mm, width of pocket is 1-4 mm, and depth between 1-4 mm.

11. A process of manufacturing a briquette comprising a metallic salt comprising steps of:
feeding a metallic salt feed to a feed hopper unit;
removing lumps from the metallic salt feed using a vibrating sieve units to obtain a uniform powder of a predefined sieve size of the metallic salt feed;
inclined conveying of the metallic salt to the briquetting unit;
briquetting of the metallic salt via briquetting unit to obtain a metallic salt briquette;
compressing the metallic salt briquette to form a metallic salt briquette stripe using one or more briquet rollers comprising a plurality of grooves;
cutting the briquette stripe using a cutting assembly, wherein the cutting assembly is situated at the end of the briquetting unit to obtain a metallic salt briquette;
transferring the metallic salt briquette to a bucket elevator by using a belt conveyor;
passing the metallic salt briquette using the bucket elevator to double deck vibrating sieve unit;
separating any loosely bound lumps of metallic salt and the metallic salt briquette; and
separately collecting of metallic salt briquette stripe and a by-product.

12. The process as claimed in claim 8, where in the metallic salt feed is at least one of nitrite, chloride, nitrate.

13. The process as claimed in claim 9, wherein the metallic salt feed is at least one of sodium nitrite (SNI) and sodium nitrate (SNA).

14. The sodium nitrite briquette as claimed in claim 8, wherein the content of sodium nitrite comprising:
0.001-0.1 ppm of mercury, 0.001-0.1 ppm of cadmium, 100-400 ppm of potassium, 0.001-0.1 ppm of chromium, 0.001-0.1 ppm of manganese, 0.001-0.1 ppm of nickel, 0.01-1.0 ppm of fluoride.

15. The sodium nitrite briquette as claimed in claim 8, wherein a content of sodium nitrite briquette comprising:
a content of sodium nitrite in the briquette is between 98% to 101%; an amount of loss on drying of sodium nitrite briquette is 0.001%-0.25% and preferably 0.11%-0.12%, wherein heavy metal content of sodium nitrite briquette is 0.0000%-0.002%, wherein the heavy metal comprising lead (Pb), an amount of chloride content in sodium nitrite briquette is between 5.0 ppm-100 ppm, wherein sulphate content of sodium nitrite briquette is 10 ppm-200 ppm, wherein heavy metal content of sodium nitrite briquette is 0.00 mg/kg-20 mg/kg, wherein the heavy metal comprising lead (Pb), and wherein content of lead is less than 0.1 ppm.
